(19) United States
(12) Patent Application Publication
(10) Pub. No.: US 2010/0104472 A1
(43) Pub. Date: Apr. 29, 2010

(54) METHOD AND DEVICE FOR MAKING A GLASS-GLASS CONNECTION BETWEEN GLASS CAPILLARY TUBES AS WELL AS A METHOD FOR REVERSING THE SAME AND A (GAS) CHROMATOGRAPH

(75) Inventor: Wilhelm Matthijs Adriaan Van Egmond, Veldhoven (NL)

Correspondence Address: BARNES & THORNBURG LLP, 750-17TH STREET NW, SUITE 900, WASHINGTON, DC, 20006-4675, US

(73) Assignee: STICHTING NLisis, AA Veldhoven (NL)

(21) Appl. No.: 12/594,080

(22) PCT Filed: Jan. 29, 2008
(86) PCT No.: PCT/NL2008/000029

§ 371 Date: Oct. 23, 2009

(30) Foreign Application Priority Data
Apr. 3, 2007 (NL) 1033635

(51) Int. Cl. C03B 23/207; C03B 37/022; C03B 37/075; G01N 30/02

(52) U.S. Cl. 422/49; 65/439; 65/494

(57) ABSTRACT

The present invention relates to a method for making a glass-glass connection between at least two coaxial, mutually overlapping, glass capillary tubes, wherein one of these two glass tubes is a column for chromatography, for example gas chromatography. Furthermore, the present invention also relates to a method for reversing such a glass-glass connection as well as to a device for making a glass-glass connection between at least two coaxial, mutually overlapping, glass capillary tubes.

The present invention relates to a method for making a glass-glass connection between at least two coaxial, mutually overlapping, glass capillary tubes. The present invention also relates to a method for reversing such a glass-glass connection. Furthermore, the present invention relates to a device for making such a glass-glass connection. Moreover, the present invention relates to a chromatograph, in which such a glass-glass connection is used.

Chromatography is a technique which is often used in laboratories for separating and optionally analysing various substances. A chromatograph is the device that is used to this end. Briefly, the principle of chromatography is as follows. A mobile phase flows along a stationary phase. A mixture of these substances is applied to the stationary phase at the beginning of the mobile phase. Subsequently, the various substances from the mixture are carried along the stationary phase by the mobile phase. The various substances are carried along the stationary phase at different speeds. The speed of the substances depends on the degree to which the substance attaches to the stationary phase and/or the mobile phase. For example, if a first substance from a mixture attaches more strongly to the stationary phase than a second substance in the mixture, the first substance in the mixture will be carried more slowly and thus will reach the end of the stationary phase later. This way, separation between the first and second substances is realised.

In chromatography, use can be made of various types of mobile phases. For example, a liquid is used as mobile phase in liquid chromatography and a gas is used as mobile phase in gas chromatography. The type of mobile phase will depend on the substances to be separated.

In chromatography, use can also be made of various types of stationary phases. In paper chromatography, a sheet of paper is used as stationary phase and in thin-layer chromatography, a plate, for example of glass or metal, is used, the plate being provided with a thin layer of a stationary phase. Another commonly used type of stationary phase is a column. In column chromatography, the stationary phase is applied to small particles that are tightly packed in a hollow tube of glass, stainless steel or plastic. Glass is the most commonly used material for chromatography columns. Capillary chromatography uses capillary tubes, of which the internal surface has been provided with a material that functions as stationary phase for separation. Such capillary columns may have a length of one metre to dozens of metres or even a hundred metres, and generally have been rolled into rolls.

The mobile phase can be carried through the stationary phase under the influence of gravity or by means of pressure, such as for example in HPLC (High Performance Liquid Chromatography) or gas chromatography.

If pressure is used to move the mobile phase (gas or liquid) through a column along the stationary phase, it is very important that the column is gas- or liquid-tight, respectively, to prevent leakage.

In gas chromatography, the column is placed in an oven, which is heated according to a certain temperature programme. During the heating programme, a gas, for example helium, is continually flushed through the column as the mobile phase. By adjusting the temperature programme, the separation efficiency for certain substances can be optimised. During such a heating programme, a gas chromatography column is generally heated in a temperature range between −50 and +350° C., depending on the applied column and the maximum allowable temperature and depending on the substances to be separated.

When a column is mounted in a chromatograph, the beginning of the column must be connected to the injector of the chromatograph, that is, the part were the mobile phase with the substances is applied to the stationary phase in the column. The end of the column is preferably connected to a detector of the chromatograph, that is, the part where the various substances being separated are detected. In addition, it may be necessary to connect two or more columns in a chromatograph, so that a longer column is obtained. Here, the end of the first column is connected to the beginning of the second column.

As the columns are capillary tubes, it is not easy to obtain a good gas- and/or liquid-tight connection, wherein the capillary is connected in such a way that an optimum flow therethrough remains possible.

With such connections, it is very important that they are gas and liquid-tight in order to prevent leakages. Such leakages are detrimental to the other parts of the chromatograph and also influence the separation and analysis negatively, which is undesirable.

Thus, the proper connection of chromatography columns is very important for a reliable measurement. Various methods for making such connections have been disclosed in the prior art. Two commonly applied methods are briefly explained hereafter.

A first method for coupling a glass capillary chromatography column to a chromatograph according to the prior art is known from U.S. Pat. No. 4,787,656. Here, a connecting device is disclosed, consisting of a rigid body with a cavity therein, an aperture that communicates with the smaller end of the cavity and a tapered ferrule with an axial aperture in it. After the chromatography column has been passed through the aperture of the ferrule, the ferrule is tightened by means of a nut and distorted as a result of which a clamping connection is formed between the chromatography column and the chromatograph.

One of the disadvantages of this first method according to the prior art is that a sufficiently gas-tight connection is not obtained. If there is insufficient gastightness, the possibility exists that contaminants will enter the chromatography column, resulting in an unreliable measurement, which is undesirable. In addition, it is possible that such a connection will loosen by vibration during use, breaking the connection. A further disadvantage is that with this method, the column must be passed through the ferrule, which ferrule is made of a slightly flexible material. Here, it is very likely that the end of the capillary column will scrape along the interior of the cavity of the ferrule, as a result of which the end of the column may become blocked by material scraped from the ferrule. Such contamination is highly undesirable.

A second method according to the prior art for coupling a chromatography column to a chromatograph is known from WO 01/86155. Said document discloses a connecting device in which a capillary tube is connected by means of a UV-curable adhesive.

A disadvantage of this second method according to the prior art is that the UV-curable adhesive is not inert. This means that at elevated temperatures, certain components of the UV-curable adhesive may leach or leak from the glued connection during use of the chromatograph. As a result, the measurement results that are obtained are unreliable, which is of course undesirable.

A further disadvantage of the abovementioned two methods is that not every laboratory worker is able to make such a connection, as this requires a great deal of dexterity, skill and experience.

The object of the present invention is to provide an improved method for connecting a chromatography column to a chromatograph or to another chromatography column.

Another object of the present invention is to make a connection that is sufficiently gas- and liquid-tight.

Moreover, it is an object of the present invention that there be no contamination of the column during the method.

It is furthermore an object of the present invention to form a connection such that there will be no contamination due to leaching during use of the chromatograph.

In addition, it is an object of the present invention to provide a method that makes it possible to form a reversible connection.

It is furthermore an object of the present invention to provide a method that can be applied by laboratory workers in a simple manner, without requiring training or much experience.

Another object of the present invention is to provide an improved device for making a glass-glass connection between at least two coaxial, mutually overlapping, glass capillary tubes, which objects correspond to the objects indicated above with regard to the method according to present invention.

One or more of the aforementioned objects are accomplished by a method according to the introduction, which method comprises the steps of:

a) coaxially introducing a first glass capillary tube, which is a first column for chromatography, with a first glass-softening temperature into a second glass capillary tube with a second glass-softening temperature, wherein the first glass-softening temperature is higher than the second glass-softening temperature;

b) heating a part of the second glass capillary tube to a temperature equal to or higher than the second glass-softening temperature and lower than the first glass-softening temperature,

c) contacting the softened part of the second glass capillary tube with the first glass capillary tube so as to form a glass-glass connection.

The term glass-softening temperature is also called “softening point” in professional jargon.

The present invention thus provides a method for making a glass-glass connection. Such a connection is inert as no other material is used in the connection besides glass, which is an inert material. After all, it is not necessary to use an adhesive. Moreover, the connection is gastight, which will be explained in more detail hereinafter. Thus, one or more of the above-mentioned objects are accomplished by the present method.

Step c) of the present method preferably comprises the application of pressure to the second glass capillary tube, which pressure is higher than atmospheric pressure. The application of pressure to the second glass capillary tube ensures a good contact between the softened part of the second glass capillary tube and the first glass capillary tube, so that a good glass-glass connection can be realised. For example, an overpressure in the range of 1 to 2 bar, preferably approximately 1.5 bar, can be applied.

It is especially preferred that the pressure be applied by means of a gas, because this distributes the pressure equally around the circumference of the glass capillary tubes and also because the pressure can then be precisely adjusted to the desired level.

Helium is the preferred gas, because it does not lead to contamination of the glass-glass connection being formed and also because it does not react with the softened glass. Naturally, other gases such as, for example, nitrogen may be used.

In a preferred embodiment of the present invention, an additional step d), comprising the cooling of the two mutually connected glass capillary tubes, is carried out after step c). This fixes or “freezes” the glass-glass connection, as it were, so that it will not come loose during use, for example due to vibration.

As the first glass capillary tube, it is preferable to use a tube having an outer diameter between 0.05 mm and 0.75 mm, specifically between 0.1 mm and 0.55 mm, which corresponds to the currently commercially available sizes for a (gas) chromatography column.

Most of the commercially available chromatography columns possess, at the time of the invention, a polyimide coating on the external surface. The present method is highly suitable for making a glass-glass connection wherein a column coated with polyimide is used as the first glass capillary tube.

The inner diameter of the second glass capillary tube is preferably 0.05 mm to 0.5 mm larger than the outer diameter of the first glass capillary tube. Hereby, a good compromise is reached between the simplicity of positioning the first glass tube in the second glass tube on the one hand and realising a stable, good glass-glass connection on the other hand. If the inner diameter of the second glass capillary tube is less than 0.05 mm larger than the outer diameter of the first glass tube, positioning without breaking the fragile first glass tube becomes highly problematic. If the inner diameter of the second glass capillary tube is more than 0.5 mm larger than the outer diameter of the first glass tube, making a glass-glass connection becomes more difficult, as a relatively larger distance will have to be bridged by the softened glass, which leads to an increased risk of cavities occurring in the softened glass, which may lead to leakages. In addition, the dead volume, defined as the total volume of gas or liquid in the column is increased, which is undesirable as it influences the signal-to-noise ratio of the measurement negatively. An important indication for the presence of an increased dead volume is obtained by recording a reference chromatogram in a column connected by using the usual methods according to the prior art and a column connected according to the method according to the present invention. A broadening of the solvent peak in the chromatography spectrum may indicate an increase of the dead volume. Such broadening is hardly found, if at all, when a column coupled according to the present method is used, which is advantageous.

Specifically, the inner diameter of the second glass capillary tube is 0.1 mm to 0.2 mm larger than the outer diameter of the first glass capillary tube, because an even better compromise is obtained this way.

It is preferable to keep the temperature during heating of both glass capillary tubes as low as possible when carrying out the method. After all, a too high temperature might firstly lead to possible damage to the stationary phase in the interior of the first glass capillary tube. Secondly, too high a temperature might lead to (partial) softening of the glass of the first glass capillary tube, which might lead to undesirable deformation of the column. Thus it is preferred that as the second glass capillary tube a tube is used with a glass-softening temperature in the range of 200-300° C., preferably 200-500° C., more preferably 350-500° C., and even more preferred 350-400° C. This range ensures a good softening of the second glass capillary tube at a temperature that involves a minimum risk of damage to the column. The presence of a polyimide coating on a column is another reason for not applying too high a temperature, as at temperatures above approximately 350° C., there will be a risk of charring of the polyimide and/or the stationary phase on the inside of a first capillary tube, which is undesirable.

To avoid reaching this temperature, or in any case limit the temperature increase for the first glass capillary tube, it is preferred to cool the first glass capillary tube, preferably by passing a cooling medium, such as a gas, through the first glass capillary tube during at least part of step b).

The time that is needed for heating to form a good glass-glass connection depends on a number of factors, such as for example the type of glass used for the second glass tube, the wall thickness of the second glass tube, as well as the difference in diameter between the exterior of the first glass tube and the interior of the second glass tube and the applied pressure. However, the present inventors have found a period of for example 1 to 40 seconds, preferably 1 to 15 seconds, to be sufficient. Those skilled in this field will be able to optimise the time, on the one hand in order to obtain a good gastight connection and on the other hand in order to prevent charring of the stationary phase or of the polyimide coating that is present.

In a preferred embodiment of the present method, a tube made of a glass of the type selected from the group consisting of borosilicate glass and lead glass is used as the second glass capillary tube. Such types of glass are known for a low glass-softening temperature and these are suitable for applying the preferred temperatures.

The present invention is also very well suited for making a glass-glass connection between two coaxial, aligned glass capillary tubes having at least substantially the same (outer) diameter, whilst an enveloping capillary tube is used around these two glass capillary tubes. Within this framework, a further preferred embodiment of the present invention is characterised in that:

in step a), the first glass capillary tube is introduced into a first end of the second glass capillary tube, whilst also a third glass capillary tube having a third glass-softening temperature is introduced into a second end of the second glass capillary tube, which first and third glass capillary tubes are in line with each other.

wherein in step b) at least a portion of the second glass capillary tube is heated to a temperature equal to or higher than the second glass-softening temperature and lower than the first and the third glass-softening temperatures,

wherein in step c) said at least one softened portion of the second glass capillary tube is contacted with the first and third glass capillary tubes to form a glass-glass connection between the second and the first and third glass capillary tubes.

Within the framework of this preferred embodiment, it is possible that there is one softened portion of the second glass capillary tube, which is contacted with both the first and the third glass capillary tube, whilst it is also possible to use two separate softened portions of the second glass capillary tube, one of which is contacted with the first glass capillary tube, whilst the other is contacted with the third glass capillary tube.

Within the framework of the latter possibility, the risk of breakage of the second glass capillary tube due to excessive thermal stresses can be limited if according to a further preferred embodiment of a method according to the invention successively
in step b), a first portion of the second glass capillary tube is heated to a temperature equal to or higher than the second glass-softening temperature and lower than the first and the third glass-softening temperatures;
in step c), the softened first portion of the second glass capillary tube is contacted with the first glass capillary tube to form a glass-glass connection between the first and the second capillary tubes;
in step b), a second portion of the second glass capillary tube is heated to a temperature equal to or higher than the second glass-softening temperature and lower than the first and the third glass-softening temperatures;
in step c), the softened second portion of the second glass capillary tube is contacted with the third glass capillary tube to form a glass-glass connection between the third and the second capillary tubes.
   Thus, first the connection between a second glass capillary tube and the first glass capillary tube is realised and then the connection between the second glass capillary tube and the third glass capillary tube.

As an alternative for contacting the softened portion of the second glass capillary tube with the first (and possibly the third) glass capillary tube by exerting an increased pneumatic pressure on the exterior of the softened portion of the second glass capillary tube, it is also possible within the framework of the present invention to exert a pressure in the direction of the first glass capillary tube on the softened portion of the second glass capillary tube, using a pressing device, in step c). Thus, there is no requirement for using various provisions that are required to realise increased pneumatic pressure on the exterior of the softened portion of the second glass capillary tube.

The present invention also relates to a method for reversing a glass-glass connection obtained according to the present method, the method comprising the steps of:

i) heating a portion of the second glass capillary tube, which is a component of a configuration of the glass capillary tubes, to a temperature higher than the second glass-softening temperature but lower than the first and possibly third glass-softening temperature;

ii) breaking the contact between the softened portion of the second glass capillary tube and the first and possibly third glass capillary tube to break the glass-glass connection.

An advantage of this method is that the chromatography column can be removed after use without damaging it. Currently, according to the methods according to the prior art, the chromatography column is cut at a of point past the connection, as a result of which the chromatography column is shortened. By using the present method, the column does not need to be cut and thereby shortened and the connecting device can be reused repeatedly. It is, however, preferred that the second glass capillary tube is replaced.

In a preferred embodiment of this method, step ii) comprises the application of an underpressure to the second glass capillary tube, which underpressure is lower than atmospheric pressure. This makes it easier to detach the softened portion of the second glass tube from the remaining tube (tubes). To this end, for example an underpressure of 1×10⁻² bar or lower can be applied.

Preferably, a chromatography column, more preferably, more specifically, a gas chromatography column, is used as the first glass capillary tube preferably. Notably in gas chromatography, it is very important that there is a gastight connection between the chromatography column and the chromatograph and possibly another chromatography column.

Moreover, the present invention relates to a device for making a glass-glass connection between at least two coaxial, mutually overlapping, glass capillary tubes, comprising positioning means for positioning a first glass capillary tube, being a first column for chromatography, and a second glass capillary tube in coaxially overlapping relationship, such that the first glass capillary tube extends into the second glass capillary tube, heating means for heating a portion of the second glass capillary tube at the location of the glass-glass connection to be made, and contact means for contacting a portion of the second glass capillary tube softened as a result of being heated by the heating means. Such a device is very well suited for carrying out the above-discussed method according to the invention, whether or not in preferred embodiments thereof. More specifically, the positioning means are in particular useful in carrying out step a), the heating means are useful in carrying out step b) and the contact means are useful in carrying out step c).

According to an especially advantageous preferred embodiment, the contact means comprise a pressure space on the outer side of at least the portion of the second glass capillary tube to be heated by the heating means, and overpressure means for creating an overpressure within the pressure space. Thus, no physical contact with the second capillary tube is required for its deformation. Such physical contact constitutes a risk factor with regard to possible contamination.

Preferably, the overpressure means comprise supply means for supplying a gas to the pressure space. The advantage of the use of gas has already been explained before.

The overpressure means preferably comprise control means for controlling the supply means such that gas is supplied to the pressure space by means of the supply means during the operation of the heating means. Thus, the pressure within the pressure space can be increased for deforming the second glass capillary tube at the moment when a temperature is reached at which softening of the material of the second glass capillary tube occurs as a result of the operation of the heating means.

In another preferred embodiment of the present invention, the overpressure means compromise discharge means for discharging the gas supplied to the pressure space by the supply means from the pressure space. This makes it possible to flush the pressure space with gas, if desired.

The discharge means may comprise a discharge passage, which is provided at the location of the connection of a wall of the pressure space to the second glass capillary tube, which would render a gastight connection of a wall of the pressure space to the second glass capillary tube unnecessary and even undesirable.

In a further embodiment, the supply means comprise a supply passage, through which gas is supplied to the pressure space, and the discharge means comprise a discharge passage, through which the gas is removed from the pressure space, wherein the supply passage and the discharge passage, seen in the axial direction of the two glass capillary tubes, are provided on two opposite positions of the glass-glass connection to be made. Thus the flushing characteristics can be improved, if desired.

The heating means are very preferably provided in the pressure space, as the distance between the heating means and the second glass capillary tube can thus remain limited, as a result of which heating of the second glass capillary tube can take place very rapidly and efficiently.

The heating means preferably extend around the second glass capillary tube to optimise the heat transfer, which can thus take place uniformly around the circumference of the second capillary tube.

The heating means preferably comprise at least one electrical resistance wire, such as for example a platinum wire, which allows a simple and yet controlled manner of heating of the second glass capillary tube and which is preferably provided in the shape of a spiral around or in any case on the circumference of the second glass capillary tube.

To position the at least two coaxial, mutually overlapping, glass capillary tubes in the vicinity of the heating means, such that heat transfer can take place as efficiently as possible, it is highly practical if two opposed electrical resistance wires are provided. The area between the two electrical resistance wires can then be used to accommodate the at least two overlapping glass capillary tubes, wherein during the positioning thereof the two electrical resistance wires can initially be arranged at a relatively large distance from one another during the positioning of the overlapping tubes, after which the resistance wires can be moved toward each other to envelop, as it were, the overlapping tubes in this manner.

To match the form of the capillary tubes as well as possible, it is preferred that the at least one electrical resistance wire is at least partially arcuate.

To prevent notch effect and to promote a smooth transition at the location of the connection between the first glass capillary tube and the second glass capillary tube, it is preferred that the heating means have an increased heat emission capacity in the centre thereof, seen in the longitudinal direction of the at least two coaxial tubes. This can for example take place, when using an electrical resistance wire, by shaping the at least one electrical resistance wire such that it has a higher density in the mentioned centre, for example by using smaller loops or by providing the resistance wire at the centre closer to the centre line of the capillary tubes.

In addition, the present device can be provided with underpressure means for creating an underpressure wihtin the pressure space. This ensures that it is possible to excecute a method for reversing a glass-glass connection as described before.

Preferably, the positioning means are arranged for positioning a second glass capillary tube, which has an outer diameter of less than 2 mm.

The positioning means may also be arranged for positioning a third glass capillary tube, for example being a second column for chromatography, such that the third glass capillary tube extends into the second glass Capillary tube and ends of the first glass capillary tube and the third glass capillary tube in the second capillary tube are directed toward each other. This is intended for realising a connection between two columns as already discussed before.

Preferably, the heating means are at least partially provided at a longitudinal position between the first glass capillary tube and the third glass capillary tube. Thus, deformation of the second glass capillary tube at one position at the location of the connection between the first glass capillary tube and the third glass capillary tube will suffice, and the second glass tube will be constricted, as it were, to make a connection between the first glass capillary tube and the third glass capillary tube.

Alternatively, a device is preferred in which a first part of the heating means is provided on the outer side of the first glass capillary tube, spaced from the end of the first glass capillary tube, seen in axial direction, and that a second part of the heating means is provided on the outer side of the third glass capillary tube, spaced from the end of the third glass capillary tube and from the first part of the heating means, seen in axial direction. Thus a connection between the first glass capillary tube and the third glass capillary tube can be realised by means of two local deformations of the second glass capillary tube.

The present invention also relates to a chromatograph, preferably a gas chromatograph, comprising a base unit provided with an injector and a detector, and at least a column provided with a glass capillary tube, which chromatograph is further provided with the device according to the invention as discussed in the foregoing, whether or not in preferred embodiments thereof.

The present invention will be explained in more detail hereinafter by means of the description of three preferred embodiments with reference to the accompanying figures, in which:

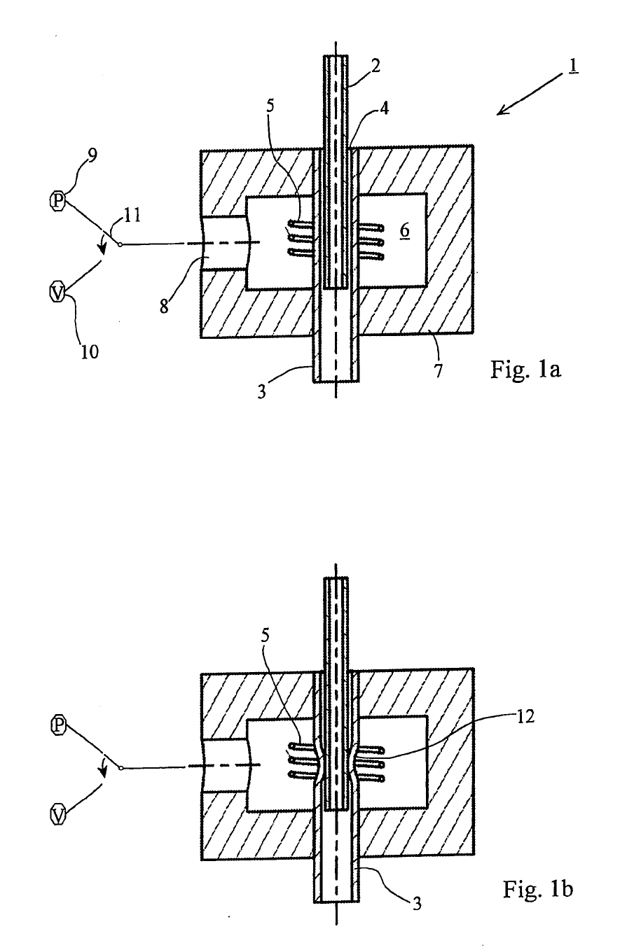

FIGS. 1a and 1b schematically show a longitudinal section of two successive stages of a first preferred embodiment of a device according to the invention when using a first preferred embodiment of a method according to the invention;

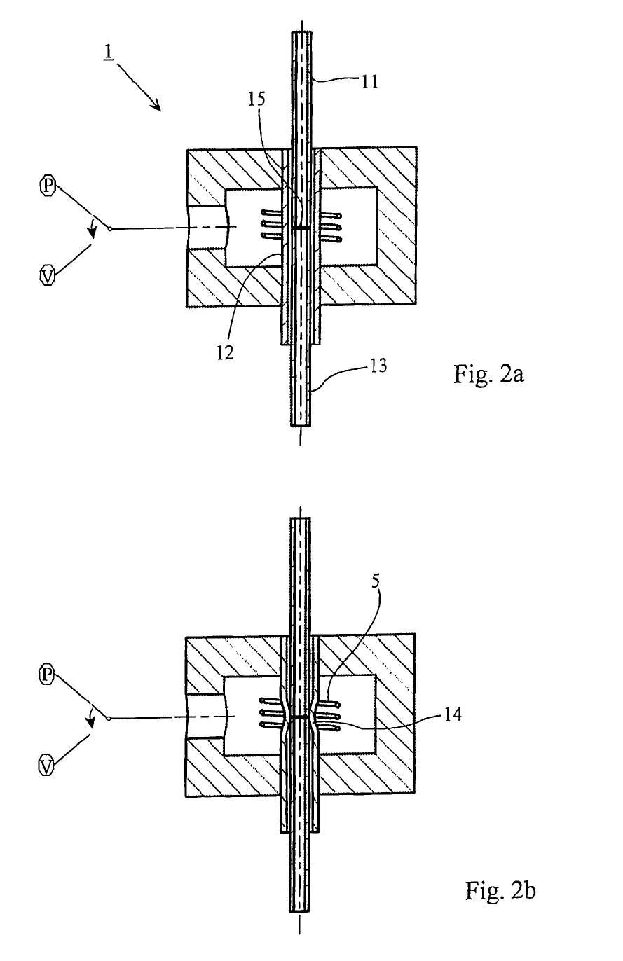

FIGS. 2a and 2b schematically show a longitudinal section of two successive stages of the first preferred embodiment of a device according to the invention when using a second preferred embodiment of a method according to the invention;

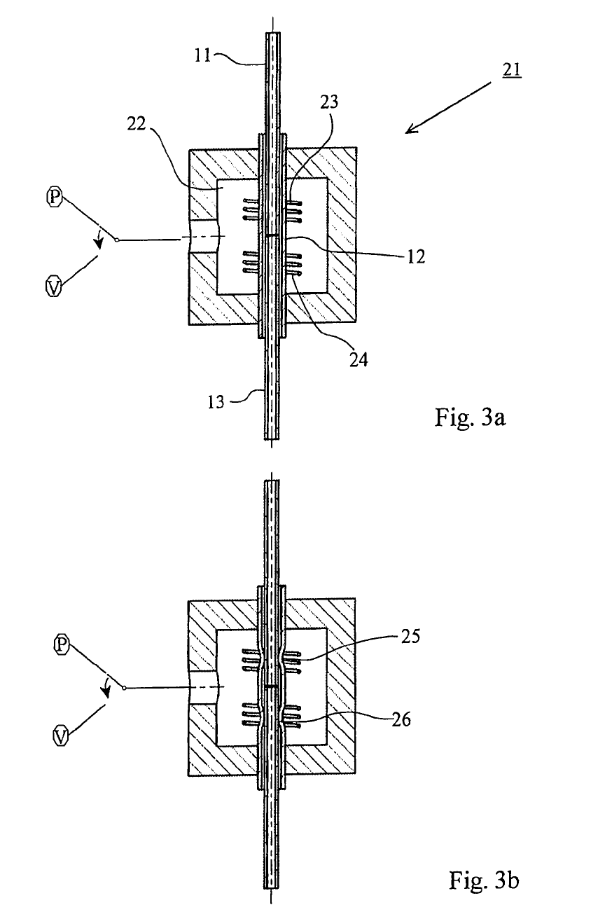

FIGS. 3a and 3b schematically show a longitudinal section of two successive stages of a second preferred embodiment of a device according to the invention when using a third preferred embodiment of a method according to the invention;

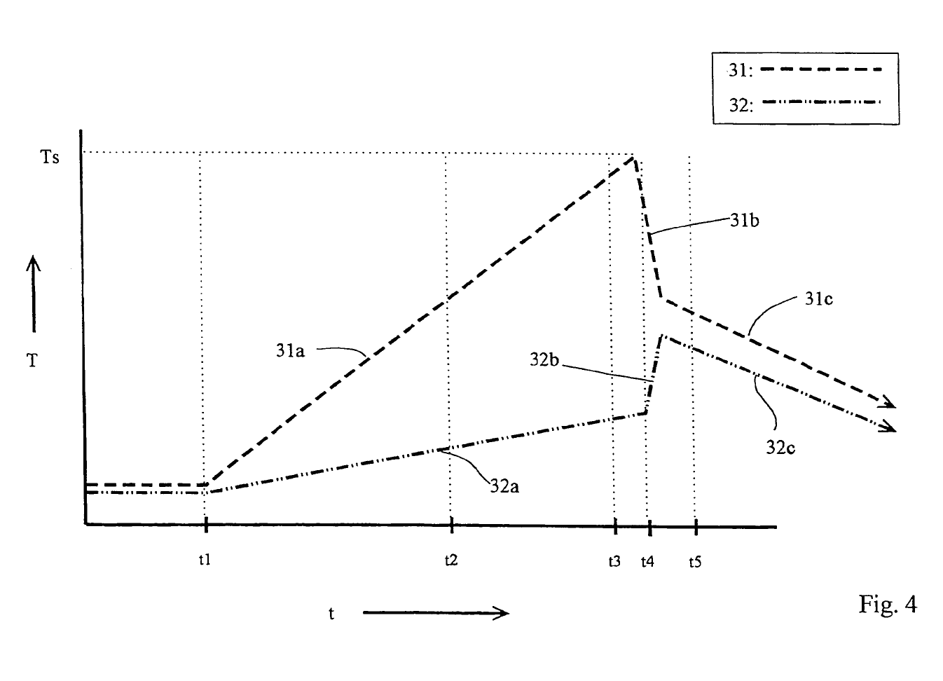

FIG. 4 is a graph showing the temperature development of the glass tubes;

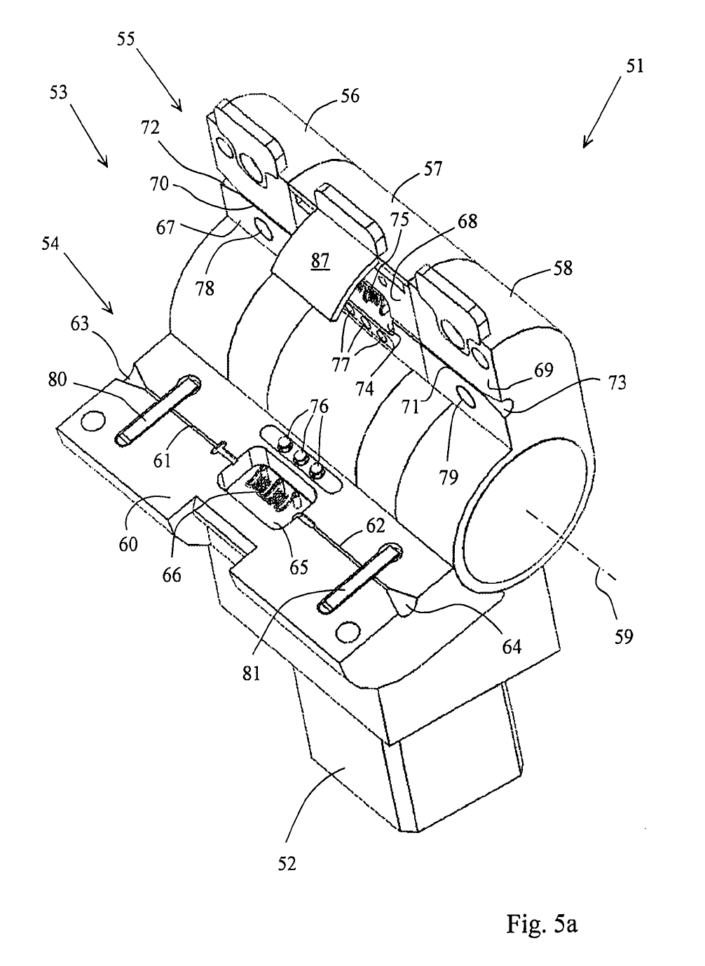

FIG. 5a shows a concrete embodiment of a device according to the invention in an open (non-operative) state;

FIG. 5b shows the device according to FIG. 5a in the closed (operative) state;

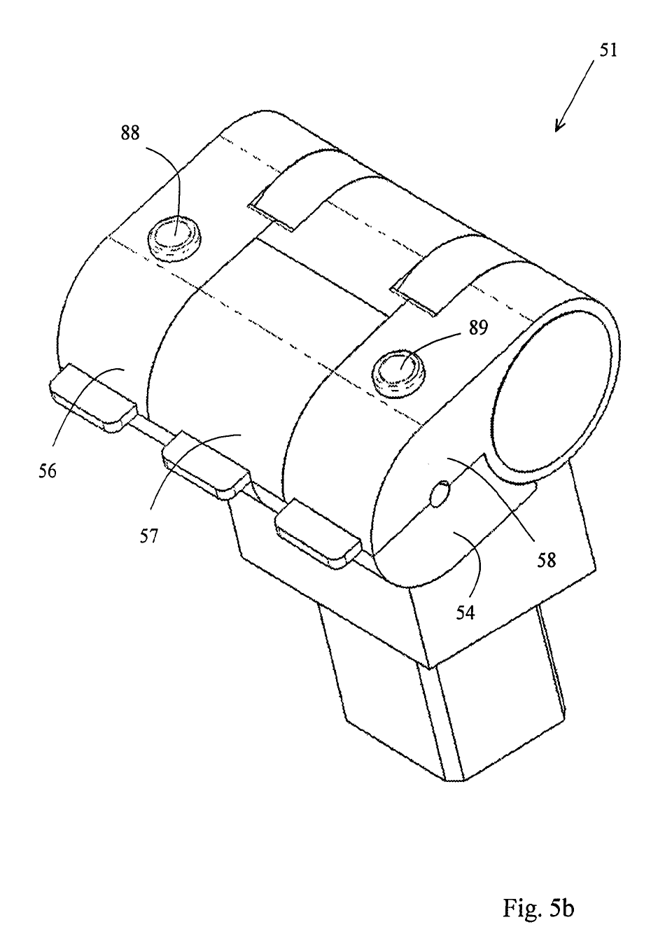

FIG. 6 shows, in isometric view, a single heating element as used with the device according to FIGS. 5a and 5b;

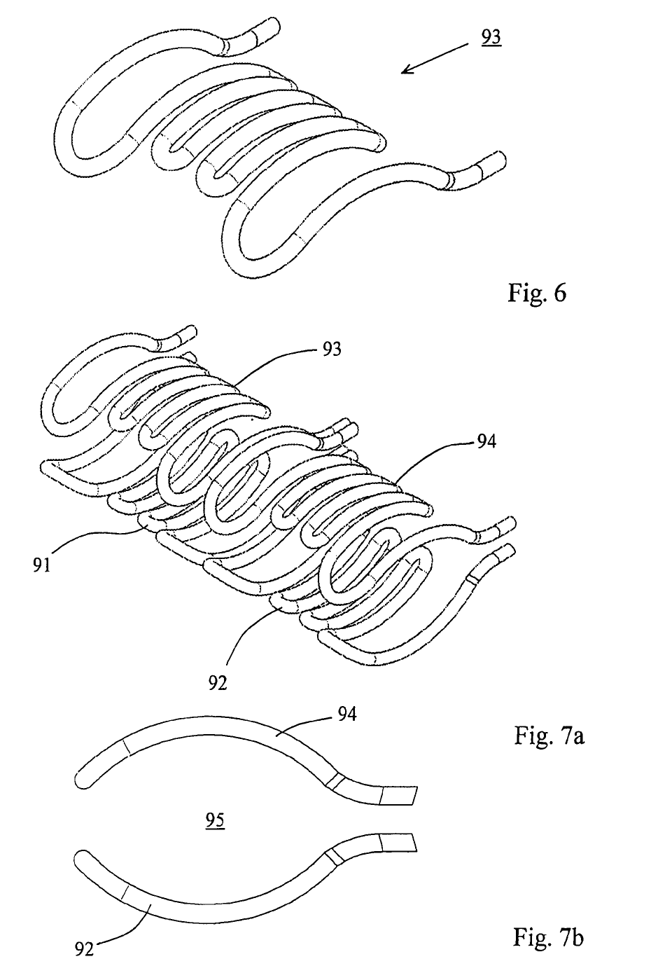

FIGS. 7a and 7b show in isometric view and in side view, respectively, four heating elements as shown in FIG. 6;

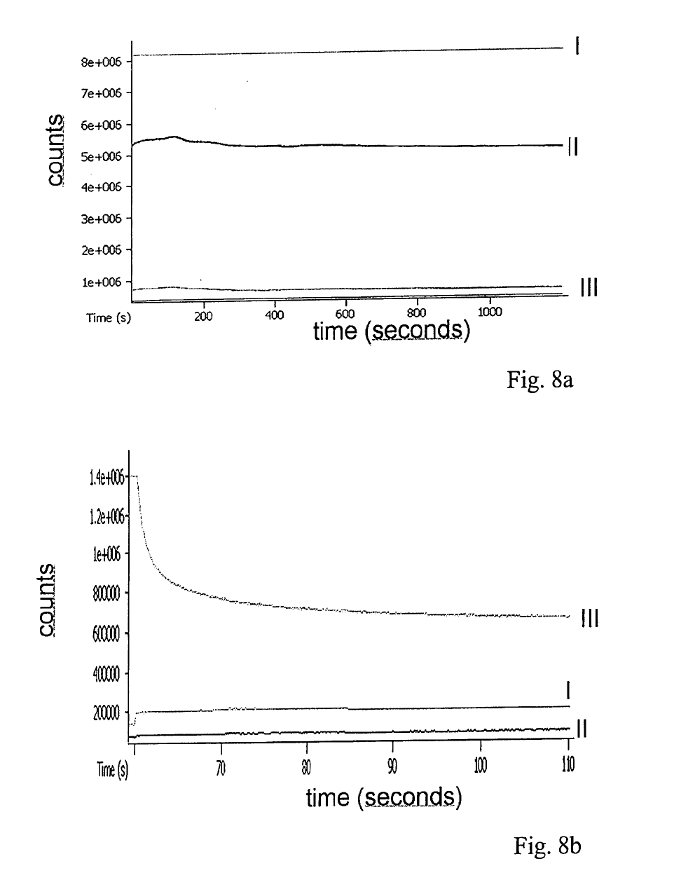

FIG. 8a is a graph which shows the leakage of ambient air into the column for a glass-glass connection according to the prior art;

FIG. 8b is a graph that shows the leakage of ambient air into the column for a glass-glass connection according to the present invention.

FIG. 1a schematically shows a longitudinal section of a device 1 for making a glass-glass connection between a first glass capillary tube 2 and a second glass capillary tube 3. The first tube 2 and the second tube 3 have been positioned coaxially relative to each other by positioning means not shown, with the second tube 3 enveloping the first tube 2 along part of its length. It will be understood that, to this end, the outer diameter of the first tube 2 is smaller than the inner diameter of the second tube 3, with a tubular gap 4 being present between the first tube 2 and the second tube 3 in the overlap area. It is indicated, only by way of illustration, that the outer diameter of the first tube 2 is for example 0.35 mm, while the inner diameter of the second tube 3 is 0.50 mm and the width of gap 4 is therefore 0.075 mm. A typical wall thickness for the first tube 2 and the second tube 3 is 0.05 mm and 0.2 mm, respectively. In the area of overlap, the first tube 2 and the second tube 3 are enveloped by a filament 5 which is arranged for locally heating the second tube 3 along the part of its length that is located within the filament 5. The filament 5 is provided within a pressure space 6 of a pressure chamber 7. Radial walls of the pressure chamber 7 abut tightly against the exterior of the second tube 3. In a wall of the pressure chamber 7, a passage 8 is provided for connecting the pressure space 6 either with a pressure source 9 or with a vacuum source 10, depending on the position of the valve 11.

FIG. 1b shows the device 1 with the two tubes 2, 3 after a glass-glass connection has been made between the tubes 2, 3 by means of the device 1. To this end, the second tube 3 is locally heated by means of the filament 5 until the second tube 3 has reached a temperature that is equal to or to a limited degree higher than the glass-softening temperature of the material of the second glass tube 3. At that moment, the pressure in the pressure space 6 has been or is increased by means of pressure source 9 as a result of which the second tube 3 will constrict locally so that constriction 12 develops of which the interior adjoins the exterior of the first tube 2 in a gastight manner. Subsequently, the filament 5 will stop heating the second tube 3, as a result of which the temperature of the second tube 3 will decrease again to below the glass-softening temperature and the glass-glass connection has been realised.

FIGS. 2a and 2b relate to a second preferred embodiment of a method according to the invention, in which the device 1 according to FIGS. 1a and 1b is used. In the second preferred embodiment of the method, like the first preferred embodiment, a first tube 11 comparable with the first tube 2 and a second tube 12 comparable with the second tube 3 are used. In addition, a third tube 13 is used, which is of the same type as the first tube 11 and which is coaxially aligned therewith. The first tube 11 and the third tube 13 are adjoining where the first tube 11 and the third tube 13 have been positioned by positioning means (not shown), in such a manner that the interface 15 between the first tube 11 and the third tube 13 is located within the filament 5.

In a manner that is comparable with the manner according to the first preferred embodiment of the method according to the invention shown in FIGS. 1a and 1b, a glass-glass connection is realised in which the second tube 12 exhibits a constriction 14 and the interface between the first tube 11 and the third tube 13 is located within the length of constriction 14, as a result of which both the first tube 11 and the third tube 13 abut against the second tube 12 in a gastight manner and consequently also the first tube 11 and the third tube 13 are connected in a gastight manner.

FIGS. 3a and 3b relate to a third preferred embodiment of a method according to the invention, which makes use of a second preferred embodiment of a device 21 according to the invention, which is different from device 1 according to the first preferred embodiment of a device according to the invention only to a limited degree. The device 21 is slightly larger, seen in the longitudinal direction, as a result of which the pressure space 22 provides space for two filaments 23, 24. The glass-glass connection between the first tube 11, the second tube 12 and the third tube 13 is not made at the location of the interface 15 between the first tube 11 and the second tube 12, as in FIGS. 2a and 2b, but instead a glass-glass connection is realised between the first tube 11 and the second tube 12, by means of the filament 23, on the one hand, and between the third tube 13 and the second tube 12, by means of the second filament 24, on the other hand, with constrictions 25, 26 being formed in the second tube 12 within the filaments 23, 24, respectively. To reduce the thermal stresses that might lead to failure in particular of the second tube 12, it is preferred to realise the two glass-glass connections in succession, more specifically, not to have the heating the portions of the second tube 12 that are to be softened by means of the filaments 23, 24 take place simultaneously.

For the reversal, if desired, of the glass-glass connections as described above, the various devices offer the possibility to reheat, by means of the various filaments 5, 23, 24, the constrictions 12, 14, 25, 26 to a temperature equal to or to a limited degree higher than the glass connection-softening temperature, after which the pressure within the pressure space 6, 22 in question is reduced by means of the vacuum source 10, as a result of which the constrictions 12, 14, 25, 26 in question will be straightened again by the exertion of a pulling/suction force, as it were, and the glass-glass connection in question is reversed.

As explained with reference to FIG. 1, the first glass capillary tube 2 can be connected to an injector or detector of a chromatograph by partially softening a second glass capillary tube 3. This, however, only is useful if the second capillary tube 3 can be connected to the injector or detector in a gastight manner. After all, the connection between the first glass tube 2 and the injector/detector must be gastight. Some commercially available injectors/detectors are fitted with a glass capillary tube of their own. In such a case, it is necessary to connect the first glass capillary tube (column) to the third capillary tube of the injector/detector by means of a second glass capillary tube. This can be done as explained with reference to FIGS. 2 and 3.

The present invention will now be explained by means of the following examples, which are only given by way of explanation and which must not be construed as being limitative.

### EXAMPLES

A gas chromatography column of the type HP5 having an outer diameter of 0.35 mm and an inner diameter of 0.25 mm, externally provided with a polyimide coating is according to the present method coupled to an injector, using a glass tube which overlaps the exterior of the column along part of its length. The glass tube is made of glass of type 357 as available from manufacturer Philips. This type of glass has a relatively low softening temperature of 379° C. The enveloping tube has an outer diameter of 0.97 mm and an inner diameter of 0.50 mm.

The column is introduced by positioning means into the glass tube within a device as schematically shown in FIGS. 1a and 1b. After said relative positioning has correctly taken place, a trajectory is carried out as qualitatively represented in the graph according to FIG. 4. The broken curve 31 shows the temperature development for the glass enveloping tube, while the curve 32 shows the temperature development for the gas chromatography column 32.

At time t1, the filament 5 is energised, as a result of which heating of the glass enveloping tube takes place according to curve 31a. Because of radiation transfer, the chromatography column heats up as well, although not as rapidly as the enveloping tube as indicated by curve 32a. At time t2, 5 seconds after t1, the pressure source 9 is energised, as a result of which helium gas is pumped into the pressure chamber 9 and an overpressure of approximately 1.5 bar develops in the pressure chamber 9. In the meantime, the temperature of the enveloping tube increases further. At time t3, 9 seconds after t1, shortly before the temperature of the enveloping tube reaches the processing temperature Ts, the filament 5 is switched off. The heating of the enveloping tube will continue, however, as the filament will continue to radiate (briefly). This results in the temperature of the enveloping tube reaching the softening temperature Ts at time t4, 10 seconds after t1, as a result of which, due to the increased pressure in pressure chamber 9, the enveloping tube will constrict inside the filament and abut tightly against the exterior of the gas chromatography column in a gastight manner. Because of the thermally conductive contact which then develops between the gas chromatography column and the enveloping tube, the former will first experience a rapid temperature increase (curve 32b), while the latter, in contrast, will experience a rapid temperature decrease. Because of the latter effect, the connection between the gas chromatography column and the enveloping tube is frozen, as it were. In any case, heating of the gas chromatography column does not take place to such a degree that the temperature of the gas chromatograph column would become so high as to damage the stationary phase thereof. Shortly after constriction of the enveloping tube, the pressure source 9 is switched off at time t5, 11 seconds after t0, after which further cooling takes place according to curves 31c and 32c.

The glass-glass connection is subjected to a number of tests to determine the gas-tightness. To this end, the gas chromatography column is closed at the upper side and an underpressure of 1×10⁻⁷ bar is generated in the interior of the gas chromatography column and the enveloping glass tube via the open lower end of the enveloping tube. It has been found that no leakage of gas takes place at the location of the connection between the gas chromatography column and the enveloping glass tube.

From the above results it is apparent, therefore, that the method according to the present invention is highly suitable for making a glass-glass connection exhibiting the required gastightness.

To reverse the connection realised in the manner described above, an experiment was carried out in which the enveloping glass tube was heated again to the softening temperature Ts. Instead of using an increased pressure, a reduced pressure of approximately 1×10⁻² was generated in the pressure chamber 6 by means of the vacuum source 10, as a result of which the constriction of the enveloping tube was sucked outwards, as it were, and the connection between the gas chromatography column and the enveloping glass tube was undone without any damage being caused to the gas chromatography column and the enveloping glass tube.

FIGS. 5a-7b relate to an actual embodiment of a device 51 according to the invention for carrying out the method according to the invention, for example as explained with reference to FIGS. 3a and 3b. The device 51 comprises a hollow leg 52, on which a positioning device 53 is provided. The positioning device comprises a stationary jaw part 54 and a composite, pivotable jaw part 55. The pivotable jaw part 55 comprises three pivotable sub-jaw parts 56, 57, 58, which can all pivot independently about a common pivot axis 59 between an open, non-operative position (FIG. 5a) and a closed, operative position (FIG. 5b).

Aligned grooves 61, 62 of arcuate cross-section with semi-funnel-shaped tapering parts 63, 64 at the ends of the stationary jaw part 54 are provided in the contact surface 60 of the stationary jaw part 54. Opposite the tapering parts 63, 64, the grooves 61, 62 open into a substantially rectangular pressure chamber 65. Inside the pressure chamber 65, heating means 66 configured as two heating elements 91, 92 to be energised independently are provided, which heating elements 91, 92 will be explained in more detail yet with reference to FIGS. 6-7b. Further, three electrical contacts 76 are provided on the contact surface 60.

If the sub-jaw parts 56, 57, 58 are aligned as shown in FIG. 5a, the contact surfaces 67, 68, 69 will form a common contact surface 67-69 which is mirror-symmetrical relative to the contact surface 60, and which is also provided with grooves 70, 71, tapering parts 72, 73, a pressure chamber 74, heating means 75 and three contacts 77.

The contact surface 60 is different from the common contact surface 67-69 in that a wire spring 80, 81 is provided above grooves 61, 62, perpendicular thereto, under which grooves are provided along the length of the wire springs 80, 81, which grooves are hidden behind the wire springs 80, 81 in FIG. 5a. In the open position, in which the wire springs 80, 81 are not loaded, the wire springs 80, 81 extend a limited distance above the contact surface 60, Opposite the wire springs 80, 81, hold-down pins 78, 79 are provided in the contact surfaces 67 and 69, which urge the springs 80, 81 in the direction of the contact surface 60 in the closed position of the device 51. The hold-down pins 78, 79 can be fixed in this position by means of snap buttons 88, 89 on the backs of the sub-jaw parts 56, 58.

Because of the (albeit limited) distance between the wire springs 80, 81 and the contact surface 60, a first glass capillary tube, with a larger capillary second connecting tube being arranged over the end thereof, which second connecting tube still extends beyond the first capillary tube in the longitudinal direction, however, can be moved from one of the tapering parts 63, 64, via the associated groove 61, 62, respectively, towards the pressure chamber 65, in such a manner that the connecting tube will be positioned opposite the heating means 66. From the opposite tapering part 64, 63, a third capillary tube can be slid through the associated groove 62, 61 into the second connecting tube with one end thereof, in such a manner that the ends of the first and the third tube will be placed in abutment with each other, or at least near each other, within the second connecting tube (comparable with the situation shown in FIGS. 3a and 3b).

The closing of the various sub-jaw parts 56, 57, 58, whether or not successively, leads to the contact surfaces 60 and 67-69 being placed in abutment with each other (FIG. 5b). The first capillary tube and the third capillary tube are clamped down in the grooves 61, 62 by wire springs 80, 81. The pressure chambers 66 and 74 form a common gastight pressure chamber. Sealing means may be provided along the circumference of the pressure chambers 66 and 74. To ensure an adequate gastightness of the common pressure chamber 66, 74, the sub-jaw part is provided with a spring-loaded hook fastener 87, which, in the closed position thereof, engages behind an edge on the stationary jaw part 54.

A passage is provided in the bottom of the pressure chamber 66, which passage is connected to a pressure source or vacuum source (comparable with the pressure source 9 and the vacuum source 10) via a valve. The pneumatic lines therefor extend through the hollow space of the leg 52. In the closed position, the heating means 66 and 75 envelop the second connecting tube. Furthermore, the contacts 76 and 77 are in contact with each other. The wiring for the electrical power supply extends through the hollow space of the leg 52. Since the contacts 76, 77 abut against each other, the heating means 75 can also be energised. In the closed position, the groove pairs 61, 70 and 62, 71 furthermore form common passages for the first capillary tube and the third capillary tube. Within this framework it is noted that according to variant no grooves 70, 71 are provided in the joint contact surface 67-69, and that the grooves 61 and 62 have a depth such that the first capillary tube and the third capillary tube fully extend within this depth.

The manner in which the device 51 can be used has already been explained in the description of FIGS. 3a and 3b and need not be explained in more detail to those skilled in the art. The device 51 may be part of a mobile unit, for example in the form of a suitcase or a laptop. The necessary pneumatic and electrical connections may be incorporated in said unit.

FIGS. 6-7b relate to the heating means 66 and 75. Each of the heating means comprises two heating elements for each jaw part 54, 55, so that in total four heating elements 91-94 (see FIG. 7a) of identical configuration are provided. FIG. 6 shows the heating element 93 separately. The heating element 93 (like the other heating elements 91, 92 and 94) is in fact an electrical resistance wire which has been bent into a number of loops and which is arcuate in side view (see also FIG. 7b). The legs of the loops in the centre of the heating element 93 are provided closer together than the legs of the two outer loops. As a result of this, more heat is given off by the heating element 93 in the centre than at the ends during operation. This has appeared to have a positive effect on the quality of the glass-glass connection because of the smoother transitions. In the closed position of the device 51, the pairs of heating elements 91, 93 and 92, 94 define an elongated, substantially tubular space 95 within the joint pressure chamber 66, 74 which is in line with the joint openings formed by the groove pairs 61, 70 and 62, 71. Inside this space 95, a second connecting tube can be irradiated from all sides by the heating elements 91, 92, 93 and 94.

When column connections are used, it is very important that these connections are gas- and liquid-tight so as to prevent leakage. FIG. 8 shows the leakage of ambient air into the column in a chromatography configuration comprising a column connection according to the prior art (press fit, in FIG. 8a) and the leakage in the case of a column connection according to the present invention (FIG. 8b). In these graphs, the measuring time in seconds is plotted along the x-axis and the signal of the detector in the arbitrary units (E) is plotted on the y-axis. The leakage is represented on the basis of the amounts of nitrogen (I) and oxygen (II) present in the mobile phase near the detector. Water (III) is present in the column used at all times, because of the column material that is used, and consequently it is present in equal amounts during both measurements.

From FIGS. 8a and 8b, the following can be concluded: In FIG. 8a, nitrogen is present in an amount of approximately 8*10⁶ units and oxygen is present in an amount of approximately 25*10⁶ units. By using the present invention, these values are lowered to 2*10⁵ units for nitrogen and to approximately 0.5*10⁵ for oxygen. The use of the column connection according to the present invention results in a strongly reduced leakage of ambient air into the column. These results show that the present invention provides an improved method for connecting a chromatography column to a chromatograph or to another chromatography column by means of a connection which is sufficiently gas- and liquid-tight.

It is emphasised that the present invention is not limited to the above-described preferred embodiments of the invention, but that the scope of the invention is primarily determined by the appended claims. In alternative embodiments, for example, use might be made of other heating means, such as tubular or dish-shaped heating elements, or heating means that operate in accordance with the principle of Curie point heating, so that heating can take place in a very precise manner. Also the manner in which the constriction of the surrounding connecting tube can be realised for contacting the same with the capillary tube, at least the part thereof positioned within said connecting tube, might be realised differently than by means of air pressure differences. Think in this connection of the application of a physical stamp, for example, by means of which the softened portion of the enveloping connecting tube can be pressed radially inwardly, or a ring which, after being heated, shrinks around the surrounding connecting tube upon being cooled.

1.-43. (canceled)

44. A method for making a glass-glass connection between at least two coaxial, mutually overlapping, glass capillary tubes, the method comprising:
coaxially introducing a first glass capillary tube, which is a first column for chromatography, with a first glass-softening temperature into a second glass capillary tube with a second glass-softening temperature, wherein the first glass-softening temperature is higher than the second glass-softening temperature;
heating a portion of the second glass capillary tube to a temperature equal to or higher than the second glass-softening temperature and lower than the first glass-softening temperature, and
contacting the softened portion of the second glass capillary tube with the first glass capillary tube so as to form a glass-glass connection.

45. The method of claim 44, wherein the contacting of the softened portion of the second glass capillary tube further comprises the application of pressure to the second glass capillary tube, which pressure is higher than atmospheric pressure.

46. The method of claim 45, wherein the pressure is applied by means of a gas.

47. The method of claim 44, further comprising cooling of the two mutually connected glass capillary tubes after the contacting of the softened portion of the second glass capillary tube.

48. The method of claim 44, wherein a tube having an outer diameter between 0.05 mm and 1.5 mm is used as the first glass capillary tube.

49. The method of claim 44, wherein a tube having an inner diameter that is 0.05 mm to 0.5 mm larger than the outer diameter of the first glass capillary tube is used as the second glass capillary tube.

50. The method of claim 44, wherein a tube having a glass-softening temperature in the range of 200-500° C. is used as the second glass capillary tube.

51. The method of claim 44, wherein the heating of the portion of the second glass capillary tube takes maximally 40 seconds.

52. The method of claim 44, wherein the temperature of the first glass capillary tube during the heating of the portion of the second glass capillary tube does not exceed 350° C.

53. The method of claim 44, wherein the first glass capillary tube is cooled by a cooling medium passed through the first glass capillary tube during at least part of the heating of the portion of the second glass capillary tube.

54. The method of claim 44
wherein, during the coaxial introduction of the first glass capillary tube into the second glass capillary tube, the first glass capillary tube is introduced into a first end of the second glass capillary tube, whilst also a third glass capillary tube having a third glass-softening temperature is introduced into a second end of the second glass capillary tube, in which the first and third glass capillary tubes are in line with each other,
wherein, during the heating of the portion of the second glass capillary tube, at least a portion of the second glass capillary tube is heated to a temperature equal to or higher than the second glass-softening temperature and lower than the first and the third glass-softening temperatures, and
wherein, during the contacting of the softened portion of the second glass capillary tube, the at least one softened portion of the second glass capillary tube is contacted with the first and third glass capillary tubes to form a15 glass-glass connection between the second and the first and third glass capillary tubes.

55. The method of claim 54, wherein successively
during the heating of the portion of the second glass capillary tube, a first portion of the second glass capillary tube is heated to a temperature equal to or higher than the second glass-softening temperature and lower than the first and the third glass-softening temperatures,
during the contacting of the softened portion of the second glass capillary tube, the softened first portion of the second glass capillary tube is contacted with the first glass capillary tube to form a glass-glass connection between the first and the second capillary tubes,
during the heating of the portion of the second glass capillary tube, a second portion of the second glass capillary tube is heated to a temperature equal to or higher than the second glass-softening temperature and lower than the first and the third glass-softening temperatures,
during the contacting of the softened portion of the second glass capillary tube, the softened second portion of the second glass capillary tube is contacted with the third glass capillary tube to form a glass-glass connection between the third and the second capillary tubes.

56. A method for reversing a glass-glass connection obtained according to claim 44, the reversing method comprising:
heating a portion of the second glass capillary tube, which is a component of an assembly of the glass capillary tubes, to a temperature higher than the second glass-softening temperature but lower than the first and possibly the third glass-softening temperature; and
breaking the contact between the softened portion of the second glass capillary tube and the first and possibly third glass capillary tube to break the glass-glass connection.

57. The method of claim 56, wherein the breaking of the contact comprises the application of an underpressure to the second glass capillary tube, which underpressure is lower than atmospheric pressure.

58. A device for making a glass-glass connection between at least two coaxial, mutually overlapping, glass capillary tubes, the device comprising:
positioning means for positioning a first glass capillary tube, being a first column for chromatography, and a second glass capillary tube in coaxially overlapping relationship, such that the first glass capillary tube extends into the second glass capillary tube,
heating means for heating a portion of the second glass capillary tube at the location of the glass-glass connection to be made, and
contact means for contacting a portion of the second glass capillary tube softened as a result of being heated by the heating means.

59. The device of claim 58, wherein the contact means comprise a pressure space on the outer side of at least the portion of the second glass capillary tube to be heated by the heating means, as well as overpressure means for creating an overpressure within the pressure space.

60. The device of claim 59, wherein the overpressure means comprise supply means for supplying a gas to the pressure space.

61. The device of claim 58, wherein the heating means are provided in the pressure space.

62. The device of claim 58, wherein the heating means extend around the second glass capillary tube.

63. A chromatograph comprising a base unit provided with an injector and a detector, and at least a column provided with a glass capillary tube, wherein the chromatograph is furthermore provided with the device of claim 58.
